(19) United States
(12) Patent Application Publication
(10) Pub. No.: US 2011/0297532 A1
(43) Pub. Date: Dec. 8, 2011

(54) APPARATUS AND METHOD FOR PRODUCING PLASMA DURING MILLING FOR PROCESSING OF MATERIAL COMPOSITIONS

(75) Inventors: Jay Chakraborty, West Bengal (IN); Sudhakar Eddula Reddy, Bangalore (IN); Mamatha Nagesh, Shimoga (IN); Ravikumar Hanumantha, Bangalore (IN); Jayeshkumar Jayanarayan Barve, Bangalore (IN); Francis Johnson, Clifton Park, NY (US)

(73) Assignee: GENERAL ELECTRIC COMPANY, Schenectady, NY (US)

(21) Appl. No.: 12/795,185

(22) Filed: Jun. 7, 2010

(51) Int. Cl. B01J 19/08; B01J 19/28

(52) U.S. Cl. 204/164; 422/186; 422/186.05

(57) ABSTRACT

An apparatus, such as a plasma generation system, is provided. The apparatus can include a chamber that may be formed, for example, substantially of insulating material. The chamber can be configured to establish therein a stable glow discharge plasma having a pressure of at least about atmospheric pressure while vibrating a sample so as to be milled by bodies contained by the chamber. For example, the chamber may vibrate and/or rotate, and the chamber can include at least one body that includes insulating material and is free within the chamber. Associated methods are also provided.

### BACKGROUND

Mechanical alloying is a processing technique for adjusting the composition of a material. Conventional mechanical alloying includes mechanical milling of a sample, which causes repeated fracturing of the sample and, consequentially, the exposure of clean, reactive surfaces. Surrounding gas species can then diffuse into and/or chemically react with the material at the exposed surface of the sample to form a desired compound. While this technique has proven useful in the synthesis of a variety of materials, conventional milling is considered an energy-intensive and time-consuming process, and in some instances the milling process does not induce a reaction between the sample and the surrounding gas sufficient to form the desired phase compositions. As such, further developments in the area of mechanical alloying may be desirable.

### BRIEF DESCRIPTION

In one aspect, an apparatus, such as a plasma generation system, is provided. The apparatus can include a chamber that may be formed, for example, substantially of polytetrafluoroethylene (PTFE) or some other insulating material. The chamber can be configured to establish therein a stable glow discharge plasma having a pressure of at least about atmospheric pressure while vibrating a sample so as to be milled by bodies contained by the chamber. For example, the chamber may vibrate at a frequency ranging from about 15 Hz to about 40 Hz and/or rotate at a rate ranging from about 50 rpm to about 500 rpm, and the chamber can include at least one body that includes insulating material and is free within the chamber.

In one embodiment, the chamber can include opposing electrodes, which electrodes may have diameters of about 20 mm and a spacing of about 15 mm to about 25 mm, with at least one electrode being coated with a dielectric layer of about 1.5 mm thickness. An energy source can be connected to the electrodes so as to establish in the chamber an electric field, which electric field may define an oscillating, roughly square wave with a field frequency of about 5 kHz and a pulse rise time of about 5 μs. In some embodiments, the chamber may be configured to receive and initiate a plasma from nitrogen, or from an atmosphere that consists substantially of argon and nitrogen in a ratio of partial pressures of about 5 to 1.

In another aspect, a method is provided that includes providing a sample and perturbing the sample (e.g., mechanically, such as by vibrating the sample together with at least one body that includes insulating material). A stable glow discharge plasma having a pressure of at least about atmospheric pressure can be established, and the sample can be exposed to the plasma while being perturbed.

In some embodiments, establishing a stable glow discharge plasma includes providing a chamber formed substantially of insulating material, such as PTFE, which chamber includes opposing electrodes having diameters of about 20 mm and a spacing of about 15 mm to about 25 mm and at least one electrode coated with a dielectric layer of about 1.5 mm thickness. An electric field defining an oscillating, roughly square wave with a field frequency 5 kHz and a pulse rise time of 5 μs can be established.

In one embodiment, a sample that includes a magnetocaloric material may be provided. For example, the sample may include providing a sample that includes a magnetocaloric material including lanthanum, iron, and silicon. A stable glow discharge plasma that includes hydrogen can be established such that about 0.1 to about 75 atomic percent hydrogen is incorporated into the sample.

### DRAWINGS

These and other features, aspects, and advantages of the present invention will become better understood when the following detailed description is read with reference to the accompanying drawings in which like characters represent like parts throughout the drawings, wherein:

FIG. 1 is a cross sectional view of a chamber configured in accordance with an example embodiment;

FIG. 2 is a perspective view of the chamber of FIG. 1; and

FIGS. 3-5 are cross sectional views of the chamber of FIG. 1 representing operation of the chamber to perform plasma-assisted reactive milling.

### DETAILED DESCRIPTION

Example embodiments presented herein are described below in detail with reference to the accompanying drawings, where the same reference numerals denote the same parts throughout the drawings. Some of these embodiments may address the above and other needs.

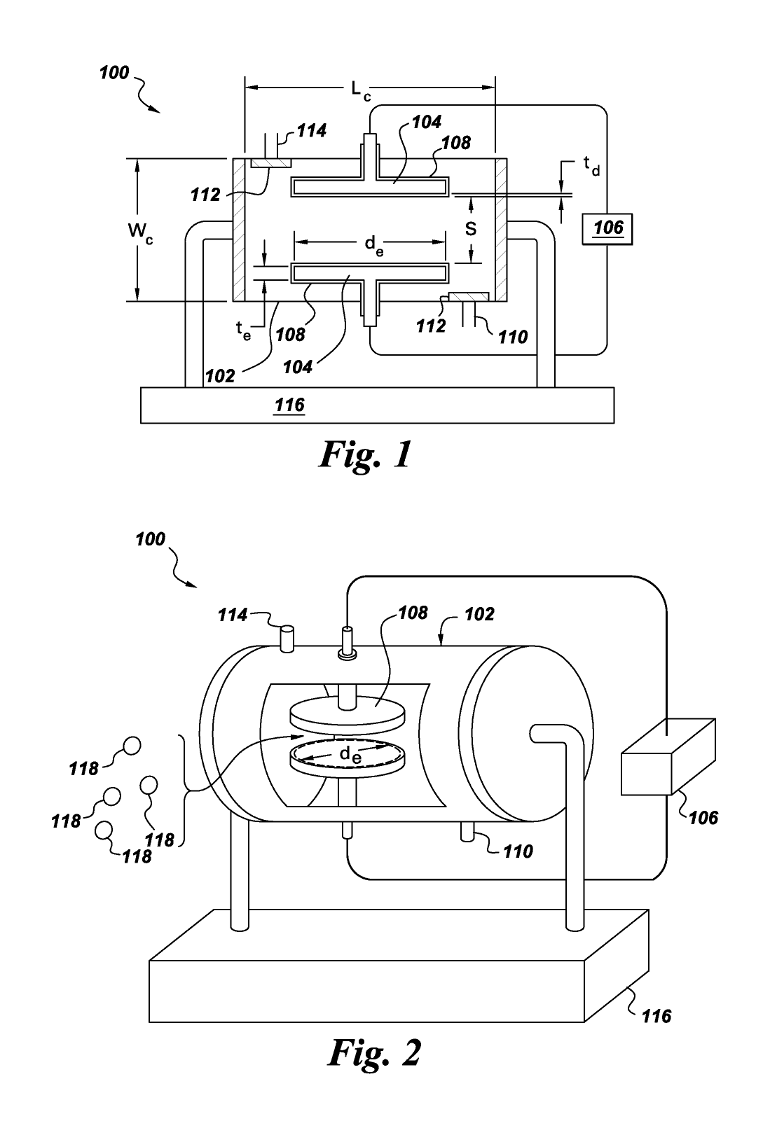

Referring to FIGS. 1 and 2, therein is shown an apparatus, such as a plasma generation system 100, configured in accordance with an example embodiment. The plasma generation system 100 includes a chamber 102. Generally, the chamber 102 may be formed of any material having a melting point more than about 150° C. and having a relatively low sputter yield under bombardment of the gaseous ions of the plasma generated by the plasma generation system 100 (the composition of the plasma is discussed further below). The chamber 102 may be formed, for example, substantially of PTFE (e.g., manufactured by E. I. du Pont de Nemours and Company (Wilmington, Del.) under the tradename TEFLON), a high-strength ceramic (for example, agate, tungsten carbide, alumina, zirconia, etc.), and/or metals/metal alloys that are coated with electrically insulating materials such as ceramics or plastics.

The chamber 102 can include opposing electrodes 104, each of which is connected to an energy source 106. In some embodiments, one or both of the electrodes 104 may be integrated with the chamber 102, for example, with the chamber being divided into two regions that are isolated from one another by an insulating partition. When in operation, the energy source 106 can establish an electric field in the chamber 102 between the electrodes 104 that oscillates at a frequency fₑ. In some embodiments, the energy source 106 may operate such that the oscillation of the electric field may roughly resemble a sine wave, while in other cases the oscillation may resemble a square wave or another function that can be represented by a series of sine waves. The electrodes 104 can have a diameter dₑ and a thickness tₑ, and can be spaced apart by a distance s.

At least one electrode 104 can be coated with a dielectric layer 108 having a thickness t_{d}. An example of a material that can be used for the dielectric layer 108 is polyoxymethylene (e.g., manufactured by E. I. du Pont de Nemours and Company (Wilmington, Del.) under the tradename DELRIN). The thickness and composition of the dielectric layer 108, as well as the composition of the electrodes 104, should be chosen so as to limit the emission of secondary electron generation from the cathode due to ion bombardment during operation of the plasma generation system 100. Where the dielectric layer 108 is composed of DELRIN, it may be useful to maintain the electrode temperature at less than or equal to about 150° C.

The chamber 102 can be configured to receive a working gas 124 through a working gas inlet 110. As discussed further below, in some cases, the working gas 124 may be nitrogen or a nitrogen-containing gaseous solution (e.g., ammonia, a mixture of nitrogen and argon, etc.). In other cases, the working gas 124 may contain oxygen, hydrogen, boron, and combinations thereof. The working gas 124 may be directed by the working gas inlet 110 through a filter 112 (such as a ceramic cloth filter that is configured to prevent particles from leaving the chamber 102 when introducing pressurized gas or generating vacuum inside the chamber) and into the chamber 102. Working gas 124 may exit the chamber 102 via a working gas outlet 114 and associated ceramic cloth filter 112. The chamber 102, including the inlet and outlet 110, 114, can be configured such that the total pressure in the chamber is about, or somewhat above, atmospheric pressure.

The chamber 102 can be configured to vibrate, for example, by coupling the chamber to a vibrating machine 116. The chamber 102 can also include at least one body that is free to move within the interior of the chamber. For example, the chamber 102 can include multiple balls 118 formed of, for example, PTFE, a high-strength ceramic (for example, agate, tungsten carbide, alumina, zirconia, etc.), and/or metals/metal alloys that are coated with electrically insulating materials such as ceramics or plastics (those being the materials of which the chamber may be composed). The balls 118 can be enclosed by but otherwise free within the chamber 102. The purpose of the balls 118 is discussed further below.

As discussed below, in operation, the chamber 102 can be utilized to simultaneously establish therein a stable glow discharge plasma having a pressure of at least about atmospheric pressure and vibrate a sample so as to be milled by the balls 118. When used to induce a chemical change in a sample, this process of simultaneous milling and plasma exposure is referred to as “plasma-assisted reactive milling.”

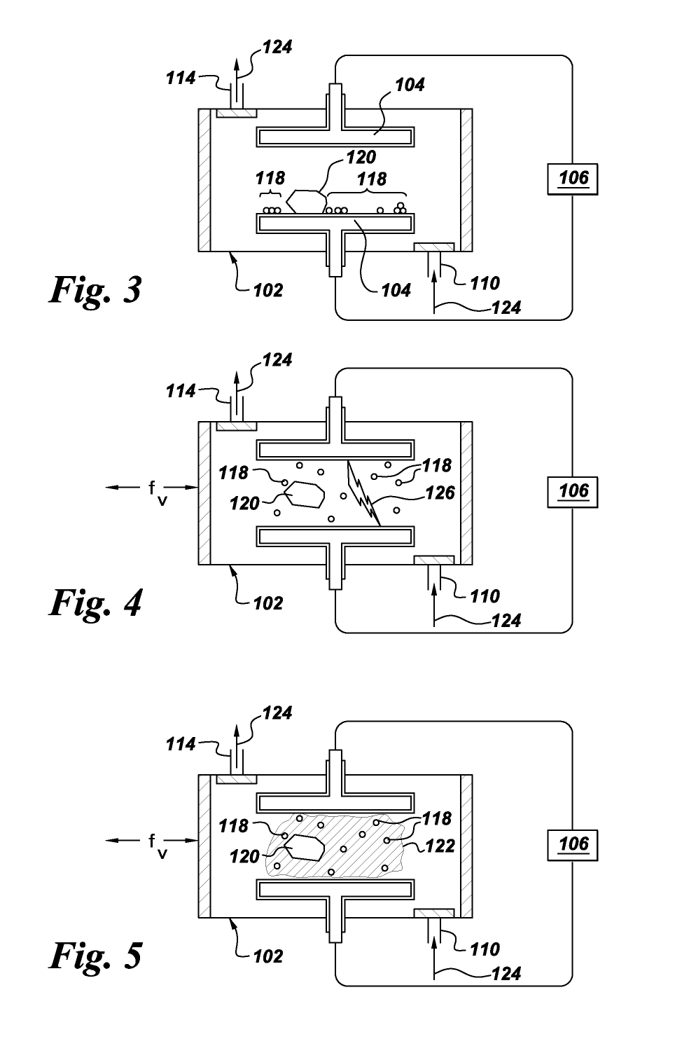

Referring to FIGS. 1-5, therein is represented an example procedure for subjecting a sample 120 to plasma-assisted reactive milling with the chamber 102. The sample 120 can be placed into the chamber 102 along with the plurality of balls 118 that act as the milling media. The sample 120 can then be perturbed, for example, by mechanically vibrating the chamber 102 (e.g., moving the chamber linearly, circularly, or in a planetary motion), including the sample together with the balls 118, at a frequency fᵥ. In other embodiments, the sample 120 may include several pieces that collide with one another to cause the perturbation of the sample.

A stable glow discharge plasma 122 having a pressure of about atmospheric pressure can be established within the chamber 102, thereby exposing the sample 120 to the plasma while perturbing the sample. A working gas 124, such as a nitrogen-containing gaseous solution, can be introduced into the chamber 102 via the working gas inlet 110, such that the total pressure in the chamber is about equal to atmospheric pressure. The energy source 106 can be operated so as to produce an oscillating electric field (with oscillating frequency fₑ) between the electrodes 104 sufficient to induce dielectric barrier discharges 126 between the electrodes. In some embodiments, the frequency fₑ can be about 5 kHz, while in other embodiments the frequency fₑ can be about 13.56 MHz, and in still other embodiments the frequency fₑ can be in the radio frequency range. The discharges can ionize the working gas 124 to initiate and, if properly controlled, sustain a plasma 122 in the area between the electrodes 104.

The plasma 122 may be sustained if the energy source 106 induces discharges so as to result in a rate of ionization greater than or equal to the rate of recombination of the ions in the plasma. The recombination rate is proportional to, amongst other things, the frequency of collisions between the molecules of the working gas 124 and, therefore, to the pressure of the working gas. For this reason, maintaining the stability of the relatively high pressure (at or above about atmospheric pressure) plasma 122 can be challenging, especially in the vicinity of a reactive milling process, where energy exchanges due to the reaction of ionized and excited species of the plasma with newly-created surfaces generated by the milling process.

Applicants have discovered that the plasma 122 can be maintained as stable through careful choices of the composition, pressure, and flow rate of the working gas 124, the vibration frequency fᵥ of the chamber 102, the oscillation frequency fₑ of the electric field produced by the energy source 106, the composition of the chamber 102 and the electrodes 104 (e.g., so as to limit the coefficient of secondary electron generation of the cathode), and the dimensions and spacing of the electrodes 104 in light of, for example, the size of the chamber and the amount of material being processed. Specifically, Applicants have discovered that some embodiments may show enhanced plasma stability when the vibration frequency fᵥ is much slower than the response time scales of the electrons and ions in the plasma 122.

Still referring to FIGS. 1-5, as an example, Applicants have utilized an apparatus 100 and method as described above to produce a stable plasma 122 while respectively performing plasma-assisted reactive milling of silicon powder and iron powder. The following process parameter values were chosen: an electric field produced by an 8 kV alternating current power supply that generates a roughly square wave with a frequency fₑ of about 5 kHz and an associated pulse rise time of about 5 μs; electrode diameters dₑ of about 20 mm; an electrode spacing s in the range of about 15 mm to about 25 mm; a layer of DELRIN with a thickness t_{d} of about 1.5 mm covering one electrode (the dielectric layer thickness will depend on the breakdown voltage of the materials in the atmosphere of the chamber); a chamber vibration frequency fᵥ ranging from about 15 Hz to about 40 Hz; a working gas consisting substantially of argon and nitrogen in a ratio of partial pressures of about 5 to 1 and a total pressure of about 1 atm; a working gas flow rate of about 1.5×10⁻⁴ l/s to about 1.5×10⁻¹ l/s; and a chamber and milling media formed of PTFE. Additionally, the chamber 102 had a chamber width w_{c} of about 44 mm and a total chamber length L_{c} of about 55 mm. Using these parameter values, Applicants successfully produced and sustained a stable plasma 122 and were able to perform plasma-assisted reactive milling to form Si₃N₄ and Fe₃N₄, respectively

As another example, Applicants have utilized an apparatus and method as described above to produce a stable plasma 122 while performing plasma-assisted reactive milling of a sample of a magnetocaloric material. The sample was an alloy composed primarily of lanthanum, iron, and silicon (La(Fe_{0.88}Si_{0.12})₁₃).

A standard Fritsch milling vial was used as the milling vessel (e.g., as the chamber), but modified to sustain pressure of up to 10 atm. Air was removed from the milling vial, which was generally pressurized with about 5 bar of hydrogen gas (mixed, in some cases, with argon). No exchange of gas was done during milling. Once pressurized, the vial was loaded into a standard Fritsch planetary mill for milling.

The following process parameter values were chosen: an electric field frequency fₑ of about 5 kHz and an associated pulse rise time of about 5 μs; electrode diameters dₑ of about 20 mm; electrode spacing s in the range of about 15 mm to about 25 mm (25 mm, in this case, being the approximate width of the chamber); a layer of DELRIN with a thickness t_{d} of about 1.5 mm covering one electrode; the mill was operated at a rotation rate of 50-500 rpm; a working gas consisting substantially of hydrogen and a total pressure of about 10 atm; and milling media formed substantially of tungsten carbide. Using these parameter values, Applicants successfully produced and sustained a stable plasma 122 and were able to perform plasma-assisted reactive milling to hydrogenate the magnetocaloric material, thereby incorporating anywhere from about 0.1 to about 75 atomic percent hydrogen into the sample, depending on, amongst other things, the time over which the sample was exposed to the plasma.

The above described process may present, in some situations, a viable alternative to traditional mechanical alloying processes that allow for mixing and mechanical milling of reacting materials in a controlled atmosphere. In the traditional approach, alloying can be mainly attributed to mechano-chemical reactions in which reacting materials are milled/fragmented to submicron particle size to create clean, highly reactive surfaces that chemically react with local gas species to form the desired compound. However, conventional milling is considered a relatively high-energy process and time consuming process.

The plasma-assisted reactive milling process described herein tends to be lower in energy and relatively less time consuming than traditional mechanical alloying processes. Again, milling can result in fresh, clean surfaces of a sample being exposed, which surfaces may tend to react with surrounding chemically active plasma species and form thin layers. As the process continues, these thin layers may be further milled down until the plasma-chemical reaction extends to the bulk of the sample being processed. However, by introducing the energy associated with the plasma, the mechano-chemical reaction can occur relatively faster and with less overall energy input. Further, due to the reduced energy needs and the relative speed of the process, the temperature of the materials being subjected to alloying tends to be lower using the method described herein than those achieved when using conventional techniques, and may even be as low as room temperature. Additionally, the plasma-assisted reactive milling process described herein, taking place at or above about atmospheric pressure nature of the process described herein may allow for the process to be carried out in a relatively simple chamber, rather than a chamber capable of maintaining a low pressure environment.

Due to the low process temperatures and short process times, processes consistent with the above description may also allow for the formation of material phases in bulk that have previously only been produced as thin layers by plasma surface treatments of materials. As such, methods consistent with those described herein can allow for a wide variety of materials to be synthesized, depending on the compositions of the sample material(s) and the working gas. For example, using a working gas that includes nitrogen (e.g., N₂, ammonia) may facilitate the production of nitrides, while using a working gas that contains oxygen may result in the production of oxides, and a working gas that combines nitrogen and oxygen may lead to the formation of oxy-nitrides. A hydrogen-containing working gas may lead to the formation of hydrides, as will the use of a hydride as the raw material to be processed (i.e., as the sample), and a boron-containing working gas (e.g., borane) can allow for borides to be formed. Examples of the wide variety of materials that may be synthesized using methods consistent with the above description may include so-called “superhard” materials (e.g., CN₃, ZrN₃, HfN₃); novel magnetocaloric hydride materials; phosphors, for lighting applications; novel hydrides for energy storage; engineered materials with a “core-shell” structure; and new hydrides, nitrides, borides, and/or oxides, perhaps in combination (e.g., oxy-nitrides, boro-nitrides, etc.).

While only certain features of the invention have been illustrated and described herein, many modifications and changes will occur to those skilled in the art. For example, embodiments of the plasma generation system 100 described above can be scaled to increase processing of large powder batches. Further, in some embodiments, the positioning, size, and shape of the electrodes may be varied. It is, therefore, to be understood that the appended claims are intended to cover all such modifications and changes as fall within the true spirit of the invention.

What is claimed:

1. An apparatus comprising:
a chamber that establishes therein a stable glow discharge plasma having a pressure of at least about atmospheric pressure while vibrating a sample so as to be milled by bodies contained therein.

2. The apparatus of claim 1, wherein said chamber includes at least one body that includes insulating material and is free within said chamber.

3. The apparatus of claim 1, wherein said chamber vibrates at a frequency ranging from about 15 Hz to about 40 Hz.

4. The apparatus of claim 1, wherein said chamber rotates at a rate ranging from about 50 rpm to about 500 rpm.

5. The apparatus of claim 1, wherein said chamber is formed substantially of PTFE.

6. The apparatus of claim 1, wherein said chamber includes opposing electrodes that have diameters of about 20 mm and a spacing of about 15 mm to about 25 mm, at least one electrode being coated with a dielectric layer of about 1.5 mm thickness.

7. The apparatus of claim 1, wherein said chamber includes opposing electrodes, further comprising an energy source that is connected to said electrodes and establishes in said chamber an electric field defining an oscillating, roughly square wave with a field frequency of about 5 kHz and a pulse rise time of about 5 μs.

8. The apparatus of claim 1, wherein said chamber is configured to receive and initiate a plasma from nitrogen.

9. The apparatus of claim 8, wherein said chamber is configured to receive and initiate a plasma from an atmosphere that consists substantially of argon and nitrogen in a ratio of partial pressures of about 5 to 1.

10. A method comprising:
providing a sample;
perturbing the sample;
establishing a stable glow discharge plasma having a pressure of at least about atmospheric pressure; and
exposing the sample to the plasma while perturbing the sample.

11. The method of claim 10, wherein said establishing a stable glow discharge plasma includes providing a chamber formed substantially of PTFE and including opposing electrodes having diameters of about 20 mm and a spacing of about 15 mm to about 25 mm, at least one electrode being coated with a dielectric layer of about 1.5 mm thickness.

12. The method of claim 10, wherein said perturbing the sample includes mechanically perturbing the sample.

13. The method of claim 10, wherein said establishing a stable glow discharge plasma having a pressure of at least about atmospheric pressure includes establishing an electric field defining an oscillating, roughly square wave with a field frequency 5 kHz and a pulse rise time of 5 μs.

14. The method of claim 10, wherein said providing a sample includes providing a sample that includes a magnetocaloric material.

15. The method of claim 10, wherein said establishing a stable glow discharge plasma includes establishing a stable glow discharge plasma that includes nitrogen.

16. The method of claim 15, wherein said establishing a stable glow discharge plasma that includes nitrogen includes establishing an atmosphere that consists substantially of argon and nitrogen in a ratio of partial pressures of about 5 to 1.

17. The method of claim 10, wherein said establishing a stable glow discharge plasma includes establishing a stable glow discharge plasma that includes hydrogen.

18. The method of claim 17, wherein said providing a sample includes providing a sample that includes a magnetocaloric material including lanthanum, iron, and silicon, and wherein said establishing a stable glow discharge plasma that includes hydrogen includes establishing a stable glow discharge plasma that includes hydrogen such that about 0.1 to about 75 atomic percent hydrogen is incorporated into the sample.

19. The method of claim 10, wherein said perturbing the sample includes vibrating the sample together with at least one body that includes insulating material.

20. The method of claim 19, wherein said vibrating the sample together with at least one body that includes insulating material includes vibrating at a frequency ranging from about 15 Hz to about 40 Hz.
